(19) United States
(12) Patent Application Publication
(10) Pub. No.: US 2005/0197997 A1
(43) Pub. Date: Sep. 8, 2005

(54) Template tag resolution aide

(76) Inventors: James B. Hopkins, State College, PA (US); Timothy D. Lee, Bellefonte, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/792,654

(22) Filed: Mar. 3, 2004

(51) Int. Cl. G06F 7/00

(52) U.S. Cl. 707/1

(57) ABSTRACT

A user interface is provided which allows a database associated with a template file to be populated and reviewed for accuracy. A template file is parsed to identify any tags therein. The user interface shows the tags identified in the template file and database entries for each of the identified tags. When populating the database, at least some of the database entries are initially blank. Database entries are inputted via the user interface for each of the tags having an initially blank entry. The user interface also shows any tags in the database that do not appear in the template file, thereby allowing a user to verify whether the template file is correct. Template files, when combined with data values in their respective databases, are used to create web pages.

### COMPACT DISC APPENDIX

This patent application includes an Appendix on one compact disc having a file named appendix.txt, created on Mar. 3, 2004, and having a size of 239,904 bytes. The compact disc is incorporated by reference into the present patent application.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Computer-assisted educational tools are exploding in popularity, especially in government and corporate continuing education settings. One type of educational tool is a simulation. The general public is most familiar with simulation programs through popular computer video games such as SimCity™ (available from Electronic Arts Inc.) and RollerCoaster Tycoon (available from Atari®, formerly Infogrames Entertainment S.A.). However, simulation programs are now being used in business environments for training and education. For example, a simulation may be used to teach how to read a financial statement and how specific business decisions may impact the balance sheet of a specific company. SimShop™, available from Strategic Management Group, Inc. (SMG), Philadelphia, Pa., is a platform for development, maintenance and deployment of simulations. By enhancing the capabilities of the simulation platform, simulation experiences can be improved and made more flexible. The present invention provides for such enhancements.

Template files (also, referred to as “templates”) are used to create dynamic web pages, such as a simulation scene. Template files contains tags which get replaced with data values from a corresponding database when a web page is requested from a web server and is prepared for delivery to a recipient for subsequent rendering by the recipient's web browser. That is, a template file, when combined with data values in the database, creates a web page. Two common types of tags are JSP (JavaServer Page) tags used to create a JSP page and ASP (Active Server Page) tags used to create an ASP page.

A web developer typically creates a template file. A data entry person then creates the database by manually reviewing the template file, manually identifying the tags in the template file, entering the tags into the database, and then entering the database values for each tag into the database. This process has at least the following disadvantages:

1. A tag in the template file may be overlooked and no entry will be made in the database for the tag.

2. A tag and database entry may be put in the database but there may not be any such tag in the template file.

3. A typographic error may occur when the tag name is typed into the database.

4. The database value may be inadvertently left blank or deleted.

If any of the above conditions occur, there will be a mismatch between the template file and the database. This will result in a web page that is missing information and/or which cannot be properly rendered. It would be desirable to have an authoring tool which improves the efficiency and accuracy of developing and checking template files and their associated databases, and which can be used by a data entry person who is not necessarily proficient in working with databases. The present invention fulfills these needs.

### BRIEF SUMMARY OF THE INVENTION

A user interface is provided which allows a database associated with a template file to be populated and reviewed for accuracy. A template file is parsed to identify any tags therein. The user interface shows the tags identified in the template file and database entries for each of the identified tags. When populating the database, at least some of the database entries are initially blank. Database entries are inputted via the user interface for each of the tags having an initially blank entry. The user interface also shows any tags in the database that do not appear in the template file, thereby allowing a user to verify whether the template file is correct. Template files, when combined with data values in their respective databases, are used to create web pages.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. However, the invention is not limited to the precise arrangements and instrumentalities shown.

In the drawings:

FIG. 1 is a diagram of a template tag resolution aide in accordance with one preferred embodiment of the present invention.

FIG. 2 is a screen shot of a user interface for use as a template tag resolution aide in accordance with one preferred embodiment of the present invention.

### DETAILED DESCRIPTION OF THE INVENTION

Certain terminology is used herein for convenience only and is not to be taken as a limitation on the present invention.

The present invention is described in the context of the SimShop™ platform described above. However, the scope of the present invention is not limited to any particular simulation platform or any particular application. Non-simulation applications can also take advantage of the present invention which allows any web application to provide for customized source file location information.

I. Overview of Template Tag Resolution Aide

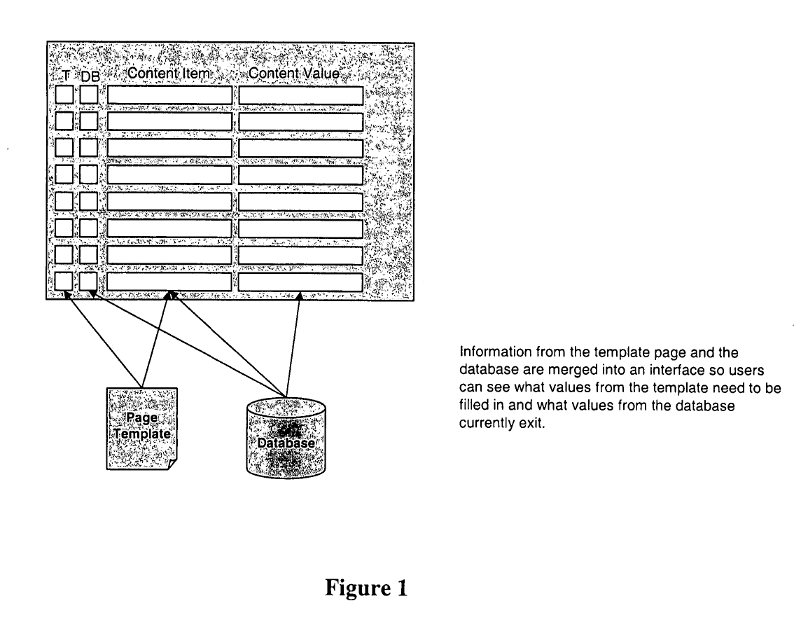

FIG. 1 shows a diagram of a template tag resolution aide in accordance with one preferred embodiment of the present invention. A software tool reads a template file and parses all the tags and presents them to the user via a user interface which allows the user to fill in the values for each tag. When the user fills in the values, they are saved into the database. The software tool also reads the database and shows the current values for each tag as well as those values not used in the template file. Thus, information from a template file and a database are merged into a single interface so that a user can see what values from the template file needs to be filled in and what values from the database currently exist. This process allows the user to see the “hole” in the template file or to identify that they have the wrong template file. This process helps uncover mismatched names, typos, and missing data. It guides the user to know what information must be filled in for the web page to display correctly. This process allows infinite flexibility in the template files (the tool does not care how many tags there are), reduces human error, and increases productivity. This process addresses all of the deficiencies discussed above with respect to the prior art manual process for creating databases associated with template files. Specifically, blank entries in the database caused by overlooked template file tags will be immediately apparent by viewing the user interface. A tag name and database entry that was put in the database but does not exist in the template file will also be highlighted. Typographical errors in the tag names will also be easy to spot since there will be two tags with close names, one of which will likely have no database entry. Furthermore, the user interface requires less programming skills than working directly with the database.

The template tag resolution aide may be used to create the database entries or to check the accuracy of a previously created database entries. More specifically, to create a database associated with a template file, the following steps are performed:

1. A template file is parsed to identify any tags therein.

2. A display screen displays a user interface that shows the tags identified in the template file and database entries for all of the tags for the web page. When creating a new database, the database entries are initially blank.

3. Database entries are inputted via the user interface for each of the tags.

4. The database is created and populated using the identified tags and the database entries.

5. If the database is already populated and the user wishes to review the template file and the database for potential errors or to further edit the template file or the database, then the database is accessed. Any tags in the database that are not in the template file are shown in the user interface. Likewise, the database entries for each of the tags located in the database, including the tags that are in the template file and any tags that are not in the template file, are also shown. The user may then edit any database entries that are either blank or that a user wishes to change.

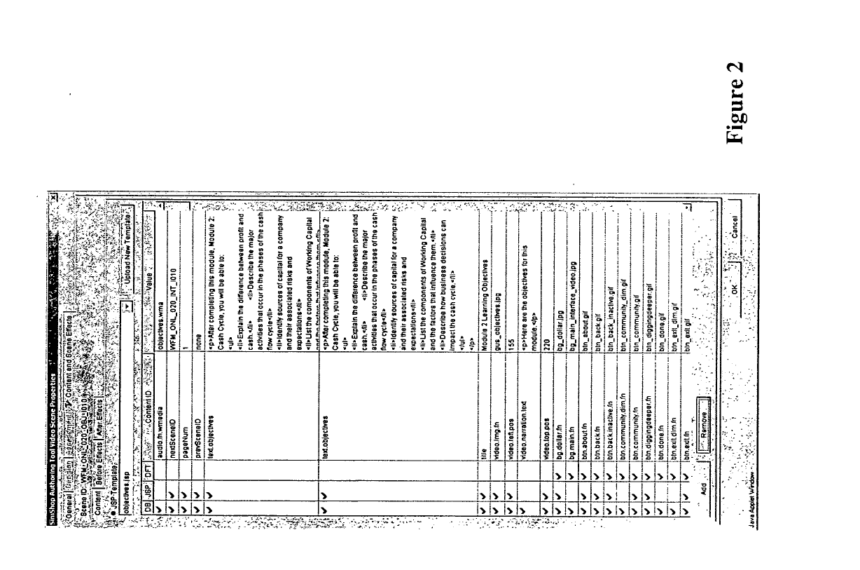

FIG. 2 shows a screen shot of a user interface for use as a template tag resolution aide in accordance with one preferred embodiment of the present invention. In this example, the template is a JSP template (here, objectives jsp) used in a simulation scene. The “scene ID” (here, WFM_ONL_{—}020_OBJ_{—}1010) refers to the page ID or web page that is ultimately rendered at the recipient's computer. The user interface has five columns, as follows:

1. DB—This provides an indication for each tag as to whether the tag is in the database.

2. JSP—This provides an indication for each tag as to whether tag is in the template file.

3. DFT—This indicates if the value is a default shared by other web pages or if it is unique to the current web page.

4. ContentID—This is the JSP tag name.

5. Value—This is the database entry value.

If a web page is programmed using Microsoft's ASP.NET framework, then the template would be an ASP template and the ContentID would be an ASP tag name.

II. Detailed Disclosure of Template Tag Resolution Aide

Part I of the Appendix provides self-explanatory source code for implementing one example of a template tag resolution aide, including table definitions.

Part II of the Appendix provides source code for a sample portion of a template, and Presentation Class. This source code further illustrates one method of implementing the present invention.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A method of creating a database associated with a template file, the template file when combined with data values in the database being used to create web pages, the method comprising:
(a) parsing a template file to identify any tags therein;
(b) displaying in a display screen a user interface that shows
(i) the tags identified in the template file, and
(ii) database entries for each of the identified tags, at least some of the database entries initially being blank;
(c) inputting the database entries via the user interface for each of the tags having an initially blank entry; and
(d) creating and populating the database using the identified tags and the database entries.

2. The method of claim 1 further comprising:
(e) accessing the database and displaying on the user interface
(i) any tags in the database that are not in the template file, and
(ii) the database entries for each of the tags located in the database, including the tags that are in the template file and any tags that are not in the template file; and
(f) editing any database entries that are either blank or that a user wishes to change.

3. The method of claim 1 wherein the tags are JSP tags and the template is a JSP template.

4. The method of claim 1 wherein step (b)(ii) further comprises displaying default values for any database entries that are not initially blank.

5. A method of checking a template file and an associated database, the template file when combined with data values in the database being used to create web pages, the method comprising:
(a) parsing a template file to identify any tags therein;
(b) displaying in a display screen the tags identified in the template file;
(c) displaying in the display screen any tags in the database that are not in the template file; and
(d) displaying in the display screen the database entries for each of the tags located in the database.

6. The method of claim 5 wherein the display screen is a user interface and the database entries are editable via the user interface, the method comprising:
(e) inputting any blank database entries.

7. The method of claim 5 wherein the tags are JSP tags and the template is a JSP template.

8. The method of claim 5 further comprising:
(e) providing an indication in the display screen for each tag as to whether the tag is in the database.

9. The method of claim 5 further comprising:
(e) providing an indication in the display screen for each tag as to whether tag is in the template file.

10. A user interface for checking a template file and an associated database, the template file when combined with data values in the database being used to create web pages, the user interface comprising:
(a) a display of a plurality of tags derived from the template file and located in the database;
(b) a display of any tags in the database that are not in the template file; and
(c) a display of database entries for each of the tags located in the database, the database entries being editable via the user interface thereby allowing any blank entries to be filled in directly via the user interface.

11. The user interface of claim 10 wherein the tags are JSP tags and the template is a JSP template.

12. The template of claim 10 further comprising:
(d) an indication for each tag as to whether the tag is in the database.

13. The template of claim 10 further comprising:
(d) an indication for each tag as to whether tag is in the template file.

14. An article of manufacture for creating a database associated with a template file, the template file when combined with data values in the database being used to create web pages, the article of manufacture comprising a computer-readable medium holding computer-executable instructions for performing a method comprising:
(a) parsing a template file to identify any tags therein;
(b) displaying in a display screen a user interface that shows
(i) the tags identified in the template file, and
(ii) database entries for each of the identified tags, at least some of the database entries initially being blank;
(c) inputting the database entries via the user interface for each of the tags having an initially blank entry; and
(d) creating and populating the database using the identified tags and the database entries.

15. The article of manufacture of claim 14 wherein the computer-executable instructions perform a method further comprising:
(e) accessing the database and displaying on the user interface
(i) any tags in the database that are not in the template file, and
(ii) the database entries for each of the tags located in the database, including the tags that are in the template file and any tags that are not in the template file; and
(f) editing any database entries that are either blank or that a user wishes to change.

16. The article of manufacture of claim 14 wherein the tags are JSP tags and the template is a JSP template.

17. The article of manufacture of claim 14 wherein step (b)(ii) further comprises displaying default values for any database entries that are not initially blank.

18. An article of manufacture for checking a template file and an associated database, the template file when combined with data values in the database being used to create web pages, the article of manufacture comprising a computer-readable medium holding computer-executable instructions for performing a method comprising:
(a) parsing a template file to identify any tags therein;
(b) displaying in a display screen the tags identified in the template file;
(c) displaying in the display screen any tags in the database that are not in the template file; and
(d) displaying in the display screen the database entries for each of the tags located in the database.

19. The article of manufacture of claim 18 wherein the display screen is a user interface and the database entries are editable via the user interface, the computer-executable instructions performing a method further comprising:
(e) inputting any blank database entries.

20. The article of manufacture of claim 18 wherein the tags are JSP tags and the template is a JSP template.

21. The article of manufacture of claim 18 wherein the computer-executable instructions perform a method further comprising:
(e) providing an indication in the display screen for each tag as to whether the tag is in the database.

22. The article of manufacture of claim 18 wherein the computer-executable instructions perform a method further comprising:
(e) providing an indication in the display screen for each tag as to whether tag is in the template file.
